(19) United States
(12) Patent Application Publication
(10) Pub. No.: US 2007/0065544 A1
(43) Pub. Date: Mar. 22, 2007

(54) Package having a food compartment and a drainage compartment and methods of use and manufacture thereof

(75) Inventors: Hal Marvin Howell III, Chicago, IL (US); Gary Herbert Carmichael, Des Plaines, IL (US); Frank Paul Leigner, Northbrook, IL (US); David Smith, Bodicote (GB)

Correspondence Address: FITCH EVEN TABIN AND FLANNERY, 120 SOUTH LA SALLE STREET, SUITE 1600, CHICAGO, IL, 60603-3406, US

(73) Assignee: Kraft Foods Holdings, Inc.

(21) Appl. No.: 11/231,346

(22) Filed: Sep. 20, 2005

(51) Int. Cl. A21D 10/02

(52) U.S. Cl. 426/112

(57) ABSTRACT

A package used for storing food and fluid having a food compartment and a drainage compartment, and methods of use and manufacture thereof. The food compartment and the drainage compartment are separated by one or more inner seals or divider walls having one or more passages. The divider permits fluid to flow from the food compartment to the drainage compartment, and to restrict fluid from flowing from the drainage compartment to the food compartment. This provides a package which can reduce the amount of fluid in the food compartment and facilitate removal of the food product from the food compartment, such as by upending the package, without also removing fluid from the drainage compartment with the food.

### FIELD

This disclosure relates generally to a package used for storing food and fluid, and more particularly to a package having a food compartment and a drainage compartment, and to methods of use and manufacture of the package.

### BACKGROUND

Food products, such as pre-prepared food products, can be sold in sealed packages. The use of sealed packages can make storage of food products easier and preserve such food products in a sealed environment. Pre-prepared food products can include, for example, pre-sliced food items or food items that have been pressure treated. Some processes result in fluid being packaged with the food product, either added to the product or from the food product itself. Packaged food products may be contained in the package in a moist condition, such that there is both food and fluid that is stored in the package. Additionally, some food products are stored in a fluid to maintain freshness and taste, i.e., pickles stored in a brine solution.

The sealed packages currently in use today for storing food products generally consist of a package that contains a single interior compartment or cavity that stores the food product and fluid together. When the food product is to be used, a section of the package is opened to permit access to the food product. A consumer can upend the package to allow the food product to fall out of the package. However, a drawback to using typical sealed packages is that the fluid contained within the package can also spill out of the package together with the food product. In many instances it is not desirable to also obtain the fluid with the food product. For example, in opening a package of pickles in a brine solution to apply to a hamburger, the consumer may not want the brine solution to spill out on top of the hamburger. To avoid this, a consumer may resort to another method of removing the food, such as using a utensil to individually remove each piece of food product from the package, or to first empty the package of food product and fluid into a separate container or strainer and to then physically separate the food from the fluid before use. Such techniques require numerous additional steps to obtain the desired food product and complicate the use of typical pre-prepared food products.

### SUMMARY

A package used for storing food and fluid having a food compartment and a drainage compartment, and methods of use and manufacture thereof, are disclosed herein. The food compartment and the drainage compartment are separated from each other by one or more dividers, such as inner seals or divider walls between side walls of the package. A fluid passage is provided between the food compartment and the drainage compartment of the package. The dividers are configured to permit fluid to flow from the food compartment to the drainage compartment and to restrict fluid from flowing from the drainage compartment to the food compartment when the package is arranged in certain orientations. This provides a package which can reduce the amount of fluid in the food compartment and facilitate removal of the food product from the food compartment, such as by upending the package, without removing the fluid from the drainage compartment with the food.

A method of use is disclosed for removing a food product from a food compartment of a sealed package containing fluid where fluid is drained into a separate compartment configured to retain fluid therein. A portion of the fluid is drained from the food compartment into a drainage compartment, such as when positioned at an elevation below the food compartment, through a passage that is sized to restrict entry of the food product. The package can be opened to gain access to the food product and the package can be upended such that the drainage compartment is disposed above the food compartment to permit the food product to be removed from the food compartment while retaining at least a portion of the fluid in the drainage compartment.

A package is disclosed that can be used for separately storing at least two food products and segregating draining therefrom. The package has at least two food compartments and a drainage compartment. The food compartments and the drainage compartment are separated from each other by at least two inner dividers and a vertical divider, i.e. a divider that is parallel to one of the side seals. A fluid passage is provided between each food compartment and the drainage compartment of the package to permit fluid to flow from the food compartments to the drainage compartment in certain package orientations. The vertical divider may also extend along the entire length of the package and divide the drainage compartment into two separate drainage compartments, each in fluid communication with one of the food compartments.

A method of manufacturing a sealed flexible package containing a food product and fluid is also disclosed, where one or more webs of film are sealed in a longitudinal direction and a pair of transverse cross seals are formed to partially define an interior of the package. At least one divider seal is also formed between the cross seals, and preferably a pair of divider seals. The divider seal divides the interior of the package into a food compartment and a drainage compartment, with a fluid passage defined therebetween. The food product is then inserted into the food compartment interior and a final longitudinal seal is formed to enclose the interior of the package.

A method of manufacturing a sealed package containing a food product and fluid with a semi-rigid or flexible back wall is also disclosed, where a web of material is advanced in a longitudinal direction and shaped by applying a vacuum when a portion of the web is disposed over a mold in order to form an interior of the package. A pair of inner wall portions are also formed within the mold that divide the interior of the package into a food compartment and a drainage compartment, with a fluid passage defined therebetween. The food product is then inserted into the food compartment interior and a layer of film is overlayed to form a seal that encloses the interior of the package. The overlayed film may have a reduced thickness as compared to the web of material for forming the back wall.

In a further aspect of the package and methods, the package may be generally rectangular, having opposing panels sealed together. The inner divider may intersect one of the side seals. Moreover, the inner divider may be linear or arcuate. The passage between the food compartment and the drainage compartment may be generally centrally located between the side seals or sides of the package when there are at least two inner dividers. Additionally, the inner divider may have multiple passages located along its length.

In another aspect of the package and the methods, a volume of the drainage compartment may be greater than the quantity of fluid in the drainage compartment and associated food compartment and in some aspects it may be greater than twice the quantity of fluid in the drainage compartment and associated food compartment. Still further, the drainage compartment may have two portions where one of the portions of the drainage compartment has a volume greater than the quantity of fluid in the drainage compartment and associated food compartment, or still further the drainage compartment may have two separate compartments where each compartment has a volume of at least greater than one half the quantity of fluid.

In another aspect, the inner divider may be a generally horizontal divider, i.e. parallel to one of a top or bottom seal, that can be sealed and subsequently removed from the remainder of the package after fluid has transferred from the food compartment into the drainage compartment, such that there would then be a separate food package with only a food compartment.

### BRIEF DESCRIPTION OF THE DRAWINGS

FIG. 1 is a perspective view of a flexible package having a food compartment and a drainage compartment;

FIG. 2 is a perspective view of the flexible package of FIG. 1, showing food in the food compartment and fluid in the drainage compartment;

FIG. 3 is a perspective view of the flexible package of FIG. 1, showing an opened package and the food product being removed from the food compartment while fluid is retained in the drainage compartment;

FIG. 4 is a perspective view of another embodiment of a flexible package;

FIG. 5 is a process flow diagram of a process for manufacturing flexible packages;

FIG. 6 is a perspective view of a tray having a food compartment and a drainage compartment;

FIG. 7 is a process flow diagram of a process for manufacturing tray packages;

FIG. 8 is a perspective view of another embodiment of a flexible package;

FIG. 9 is a perspective view of another embodiment of a flexible package having multiple food and drainage compartments; and

FIG. 10 is a perspective view of another embodiment of a flexible package having a separable drainage compartment.

### DETAILED DESCRIPTION OF THE DRAWINGS

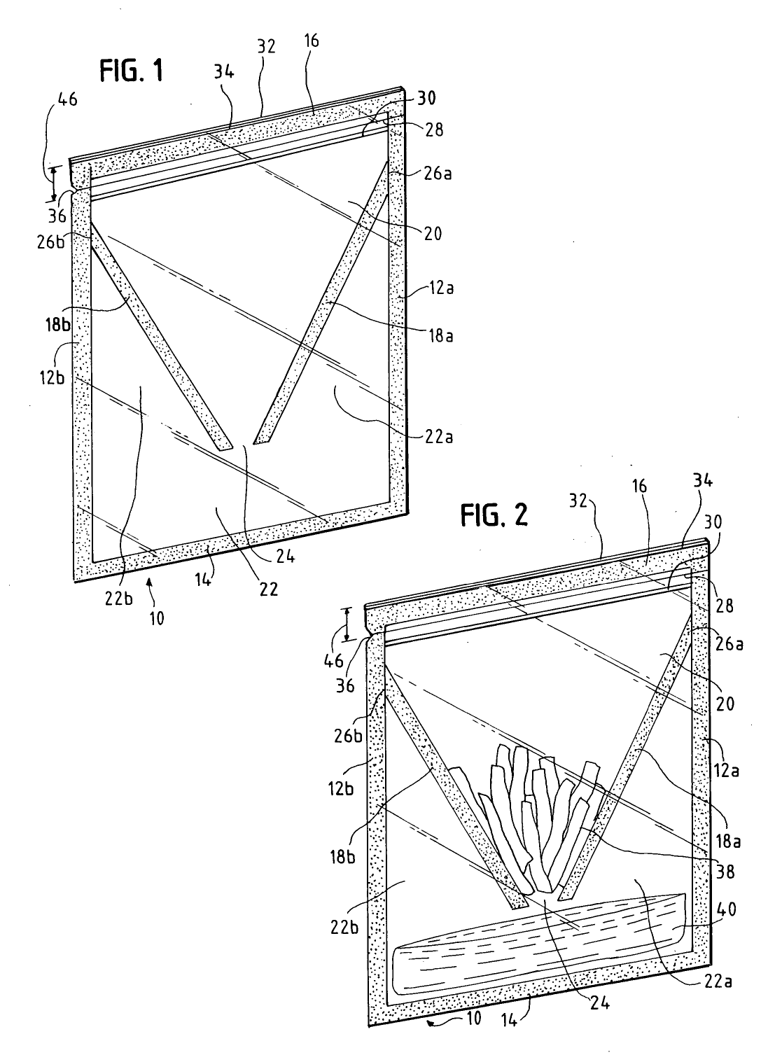

A package, and methods of manufacture, having a food compartment and a drainage compartment are disclosed herein and illustrated in FIGS. 1-10. The food compartment and the drainage compartment may be separated by at least one divider, such as an inner seal or interior divider wall, which also defines at least in part a passage between the food compartment and the drainage compartment of the package. The dividers are configured to direct fluid from the food compartment to the drainage compartment and to restrict fluid from flowing from the drainage compartment to the food compartment when the package is arranged in certain orientations. Accordingly, a package is provided which can reduce the amount of fluid in the food compartment and facilitate removal of the pre-prepared food product from the food compartment, such as by upending the package to orient the food compartment below the drainage compartment.

Turning to the details of a package 10, as illustrated in FIG. 1, the package 10 consists of two opposing film panels that make up a front wall 34 of the package 10 and a back wall 32. The package film may be of a single material type, such as polyolefin materials, including polyethylene and polypropylene, but may also comprise a laminate assembly or coextrusion of several different material types, such as those used to preserve food freshness. The panels are sealed together at outer edges of the package 10 to provide a completely enclosed package 10. The package 10 may be rectangular, although other shapes can be equally suitable. The package 10 consists of two side seals 12a and 12b, a bottom seal 14, and a top seal 16. The two side seals 12a and 12b and the bottom seal 14 can be sealed initially to define a package interior. Once the package 10 is filled, then the top seal 16 can be made to enclose the package interior. Alternatively, at least one of the outer edge seals may comprise a fold. For example, the bottom seal 14 may comprise a fold with the opposing panels or walls being formed from a continuous sheet of plastic material. The four outer edge seals 12a, 12b, 14 and 16 define an interior section of the package 10, which can be used to store food products 38 and fluid 40.

A pair of inner seals 18a and 18b are formed between the package walls to divide the package interior into at least two compartments, a food compartment 20 and a drainage compartment 22. The food compartment 20 is bordered by the top seal 16, the pair of inner seals 18a and 18b and a portion of the two side seals 12a and 12b. The drainage compartment 22 is bordered by the bottom seal 14, the pair of inner seals 18a and 18b and a portion of the side seals 12a and 12b. The food compartment 20 may be used for storing a combination of food products 38 and fluid 40, while the drainage compartment 22 may be used for storing fluid 40. As illustrated and described herein, the desired product is stored in the food compartment 20, and the drainage compartment 22 stores the undesired product; however, in some instances the fluid 40 may be the desired product.

The inner seals 18a and 18b intersect the side seals 12a and 12b at intersection points 26a and 26b, respectively. The inner seals 18a and 18b extend downward from the intersection points 26a and 26b towards the drainage compartment 22 of the package 10. For example, one of the inner seals 18a may intersect side seal 12a at an intersection point 26a and extend downward at an incline therefrom, such that the angle formed between the inner seal 18a and the portion of the side seal 12a adjacent the drainage compartment is less than ninety degrees. Such an incline can advantageously direct fluid from the food compartment 20 to the drainage compartment 22 when the food compartment 20 is elevated above the drainage compartment 22. The inner seals 18a and 18b are configured such that the ends of the inner seals 18a and 18b closest to the bottom seal 14 are closer together than the ends of the inner seals 18a and 18b adjacent the side seals 12a and 12b. At the ends of the inner seals 18a and 18b opposite their intersections 26a and 26b with the side seals 12a and 12b there is a passage 24 which permits fluid communication between the food compartment 20 and the drainage compartment 22. The passage 24 is preferably centrally located between the side seals 12a and 12b.

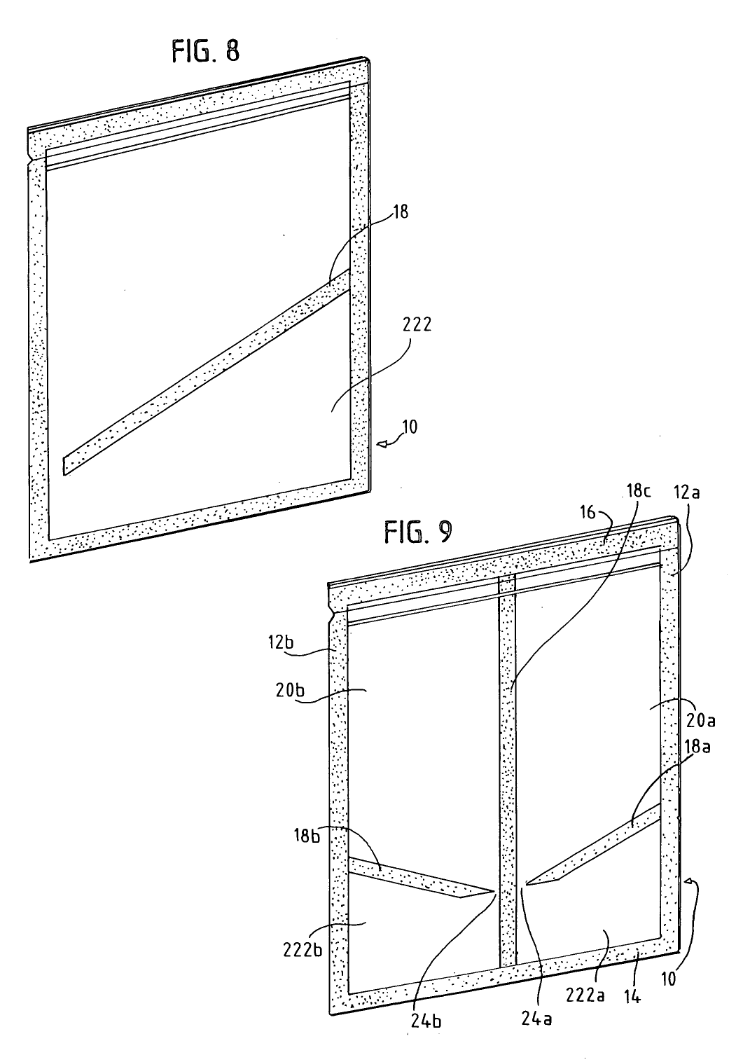

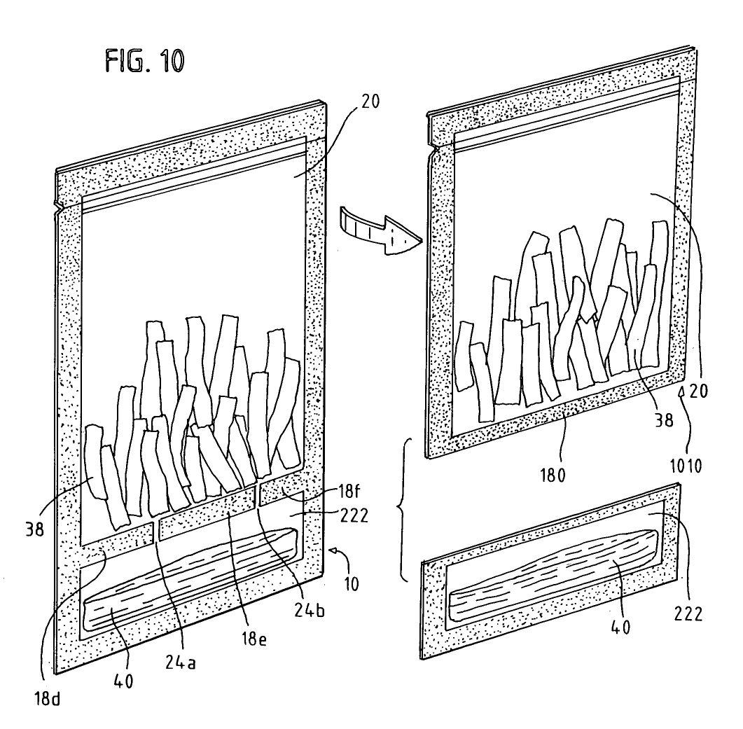

The opening of the passage 24 is sized to allow fluid 40 to pass through it but to restrict entry of food products 38. In another alternative, the inner seals 18a and 18b may comprise a single seal 18, as in FIG. 8, with one or more gaps therealong, or may consist of multiple seals with one or more passages or gaps therebetween, as in FIGS. 9 or 10, as opposed to two distinct inner seals 18a and 18b with a single passage 24 located therebetween. An example of multiple seals with multiple passages may consist of a single divider seal 18c that extends between the top and bottom seals 16 and 14 of the package 10, parallel to a side seal 12a or 12b, and between the two inner dividers 18a and 18b, as shown in FIG. 9, thus dividing the food compartment into two separate compartments 20a and 20b. The vertical divider seal 18c may extend all the way to the bottom seal 14, thus creating two separate fluid compartments 222a and 222b as well. Alternatively, the vertical divider 18c may be about at least as long as the end of the inner dividers 18a and 18b defining the passage, such that a single drainage compartment exists. A passage 24a and 24b extends between each food compartment 20a and 20b and its associated drainage compartment 222a and 222b.

If a larger food compartment 20 as compared to drainage compartment 22 is desired, the inner seals 18a and 18b can be located more closely toward the bottom seal 14. Alternatively, if a larger drainage compartment as compared to food compartment is desired, the inner seals 18a and 18b can be located more closely toward the top seal 16. Another way to increase the comparative size of one of the compartments 20 or 22 is to use non-linear inner seals or dividers. For example, arcuate inner seals 118a and 118b may be used, as shown in FIG. 4.

The drainage compartment 22 has two subsections, a first drainage section 22a and a second drainage section 22b. The first drainage compartment 22a is bordered by a portion of the side seal 12a, a portion of the bottom seal, and the inner seal 18a. Similarly, the second drainage compartment 22b is bordered by a portion of the side seal 12b, a portion of the bottom seal 14, and the inner seal 18b. In one embodiment, the smaller drainage sections 22a and 22b may be triangular shaped, which is typical when the inner seals 18a and 18b are linear; in another embodiment, the smaller drainage compartments 22a and 22b may have arcuately shaped regions, such as when the inner seals 18a and 18b are arcuate. The drainage compartment 22 has a total volume that is capable of retaining a quantity of fluid 40 that is greater than twice the fluid 40 disposed within the package 10. Additionally, the volume of one of the smaller drainage sections 22a or 22b is greater than the quantity of fluid 40 disposed within the package 10, such that if all of the fluid 40 within the package 10 were to drain into the drainage compartment 22 it could all be contained within either one of the smaller drainage sections 22a or 22b. In another embodiment, as shown in FIGS. 8 and 10, the total volume of the drainage compartment 222 is greater than the quantity of fluid 40 disposed within the package 10. In yet another embodiment, as shown in FIG. 9, the total volume of the drainage compartments 222a or 222b is greater than one half the quantity of fluid disposed within the package 10.

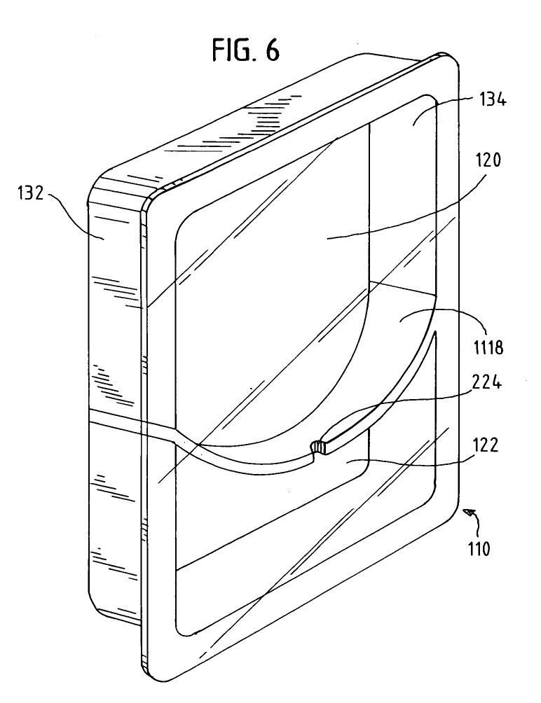

In an alternate package embodiment, illustrated in FIG. 6, the package 110 may comprise a semi-rigid tray 132 covered with a flexible film or sheet 134, or alternatively, a flexible tray 132 covered with a flexible film or sheet 134. The flexible film 134 is placed over the tray bottom 132 and sealed to the top portion or periphery of the tray bottom 132. The tray 132 consists of cavities which are the food compartment 120 and the drainage compartment 122. The compartments 120 and 122 are separated by a divider wall 1118, which contains a generally centrally located groove 224 in an upper portion of the divider wall 1118. Once the front film 134 is removed, the food compartment 120 is exposed and the desired food product may be removed while a quantity of fluid is retained in the drainage compartment 122.

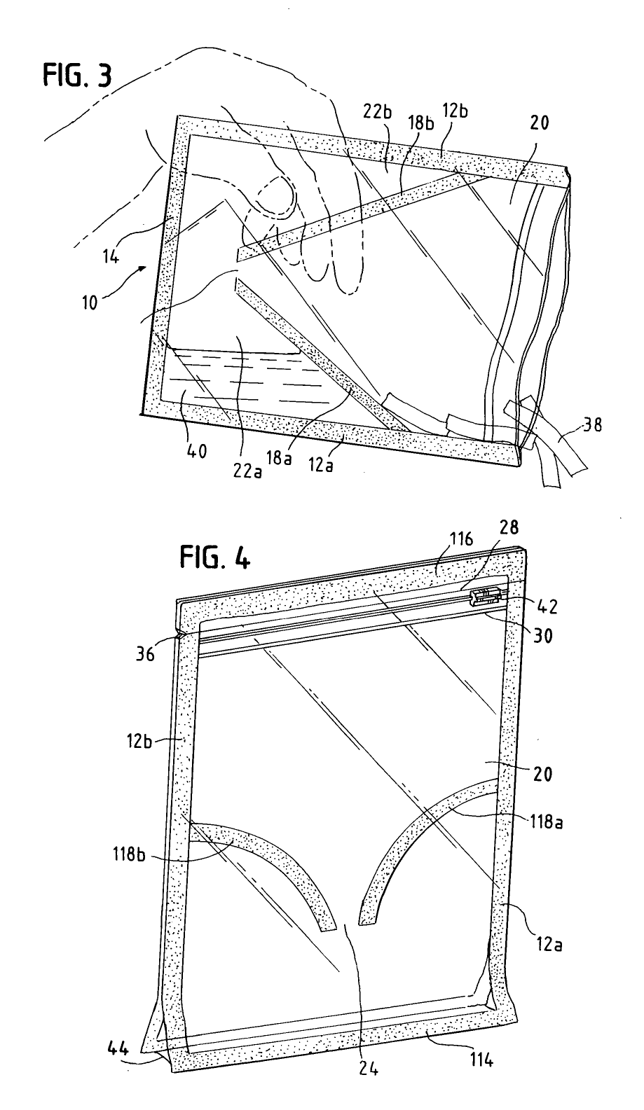

The package 10, as shown in FIG. 2, may store the food product 38 until it is ready for use. When the package 10 is maintained in an upright position, such as when the food compartment 20 is disposed above the drainage compartment 22, fluid 40 contained in the food compartment 20 or within the food product 38 itself may tend to flow along the inner seals 18a and 18b toward the drainage compartment 22. Some of the fluid 40 that flows towards the drainage compartment 22 may continue to flow through the passage 24 and into the drainage compartment 22. In the upright position, most of the fluid 40 in the drainage compartment 22 is not in either of the first drainage section 22a or the second drainage section 22b, as shown in FIG. 2. However, when the package 10 is upended, such that it is rotated at least greater than ninety degrees or where the drainage compartment 22 may be elevated above the food compartment 20, the fluid 40 may be retained in either the first drainage section 22a or the second drainage section 22b, as shown in FIG. 3, or in both. The total volume or quantity of fluid 40 in the drainage compartment 22 can be stored entirely in either the first drainage compartment 22a or the second drainage compartment 22b when the package 10 is upended or tilted either clockwise or counterclockwise.

Once the package 10 is ready for use, the consumer can remove a portion of the package 10 in order to gain access to the food product 38. For example, the consumer may remove an upper portion 46 of the package 10 such that the top seal 16 is removed together with the upper portion 46 and the food compartment 20 becomes accessible. However, other methods for gaining access to the food compartment 20 may be employed. For example, the top edge of the package 10 may contain either a top seal 16 spaced some distance therefrom or a top seal 116 at the top periphery edge. Where the top seal 16 is spaced some distance from the top edge, the front wall 34 and back wall 32 of the plastic sheets may extend upwards therefrom without being sealed together. This allows a consumer to grasp the front wall 34 and the back wall 32 and to pull the two sheets apart from one another with an adequate force to overcome the top seal 16 and cause it to either tear or separate. Additionally, if the food product is packaged under vacuum fluid can be retained in the food product while the vacuum seal is maintained, i.e. while the package is closed. Once the package is opened, the vacuum seal is lost and the fluid within the food product can be released and drained.

The alternate package embodiment 110, as shown in FIG. 6, may be opened by simply removing at least a portion of the film 134 to expose the interior cavity of the food compartment 120. The draining of fluid is accomplished in a similar manner as with the draining of the flexible package. The film 134 may only be removed from the portion of the tray 132 adjacent the food compartment 120, or the film 134 may be removed from both the food and fluid compartments 120 and 122. For example, the consumer may upend the package 110 either by rotating the tray one hundred eighty degrees so that the tray is upside down, in which case the portion of the front film 134 that remains sealed to the back wall of the tray 132 acts as a barrier and thus prevents any fluid from seeping out; or by rotating the tray about its longitudinal access such that the drainage compartment 122 is elevated above the food compartment 120, in which case the fluid would be retained in the drainage compartment 122 in a similar manner as with the drainage compartment 22 of the flexible package 10.

In the embodiment of the package 10 shown in FIG. 1, there may optionally be a horizontal score line 28, thinned die line, or perforated line just below the top seal 16 and horizontally placed across the upper portion 46 of the package 10 from one side to the other. At one termination point of the horizontal score line 28 there may be a notch 36, which can resemble a small cut out section or indention. This notch 36 provides a location for the tearing of the upper portion 46 of the package 10 to begin to propagate along the score line 28. For example, a consumer can grasp the package above the notch 36 and begin to tear the package 10 from that point and to continue to pull the upper section 46 of the top edge of the package 10 horizontally across the score line 28, causing the upper portion 46 to separate completely from the package 10. The upper portion 46 separates from the horizontal score line 28 upwards, including the top seal 16 portion. Thus this allows the food compartment 20 to become accessible. In addition, the package 10 may also include a hermetic seal in the form of a peelable seal, or peel seal 30, which may be located below the score line 28. This peel. seal 30 may provide an additional barrier between the food compartment 20 and the outside of the package 10 once the upper section 46 and top seal 16 are removed. For example, if the top seal 16 is inadvertently separated from the package 10 then the peel seal 30 still would provide protection from full exposure. Once the upper portion 46 is removed, the peel seal 30 may be easily opened by pulling apart the opposing front wall 34 from the back wall 32. Another embodiment may be to insert a reclosable means at the top of the package 10 to allow only a portion of the food product 38 to be removed while permitting continued storage of the remaining food products 38 in the package 10. One such example of a reclosable means may be a slide closure 42, consisting of a slider tab and fastener tracks which may be located below the upper portion 46 that consists of the top seal 16 and score line 28, but above the peel seal 30, as illustrated in FIG. 4. The slide closure 42 allows for the slider tab to be moved across the package top horizontally, where movement in one direction closes the package top by causing the fastener tracks to interlock or mate for closure and movement in the opposite direction opens the package top causing the fastener tracks to unmate or separate thus opening the flexible package for access to its contents in the interior. Additionally, a gusset 44 or pleated bottom may alternatively be provided, as shown in FIG. 4. The gusset 44 can permit the package 10 to stand upright, such that the food compartment 20 is above the drainage compartment 22. Alternatively or in addition, the gusset may be located on top of the package instead of or in addition to the bottom. A gusset located on the top can allow for a larger food compartment capable of holding more food product.

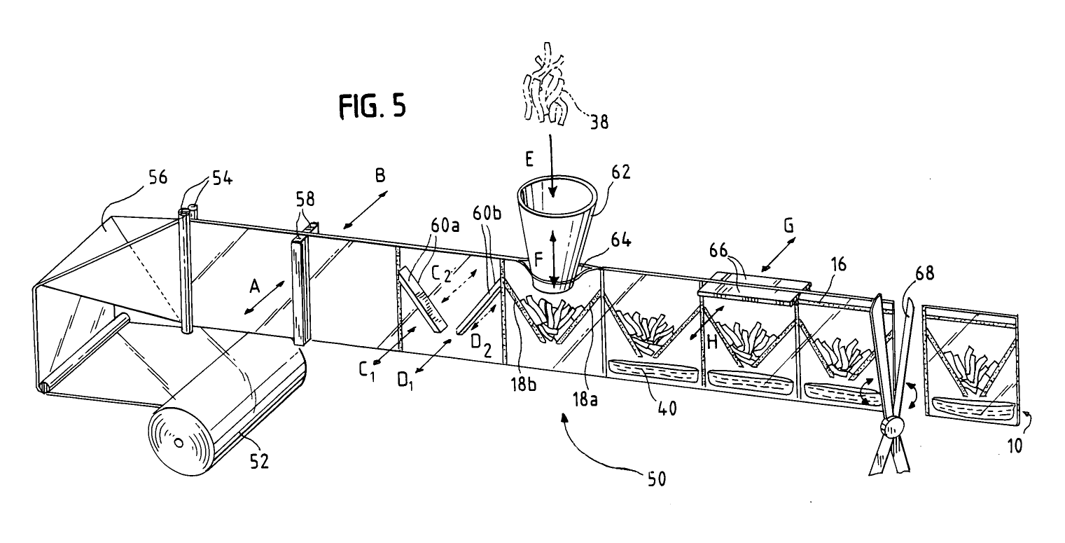

A variety of methods for manufacturing the packages described herein can be utilized. For example, the flexible package 10 can be made using the apparatus 50 and process diagrammed in FIG. 5. A web supply roll 52 provides a supply of web material, such as a conventional plastic packaging film. The web material 52 is typically advanced in a longitudinal process direction. The web material 52 passes over a triangular plate or plow 56 where the web 52 is folded about the plow 56 to form a fold at the bottom of the web. Once the web 52 passes over the plow 56, it then comes into contact with a pair of vertical roller bars 54, which may aid in aligning the front and back wall of the web in an upright, opposing position. As an alternative to the simple fold at the bottom of the package, a gusset blade may be utilized to form the gusset 44 in the bottom of the folded web.

Next, the web 52 is advanced to a pair of vertical sealing bars 58 which cooperate to form the side seals 12a and 12b. The sealing bars 58 are pressed against the web material 52 in the direction of arrows A and B, and once the seal is formed, they retract in the opposite direction. This sealing is repeated as the web 52 is advanced still further in a longitudinal direction to form another side seal. The sealing bars 58 continually form side seals along the web, such that there is a series of side seals designating numerous packages all serially formed along the web and connected to one another.

After the side seal is formed, then the next step is to form the inner seals 18a and 18b utilizing diagonal sealing bars 60a and 60b. The sealing bars 60a and 60b are pressed against the web, as designated by arrows C1, C2 and D1, D2, and retract from the web in the opposite direction. In an alternate process step, all of the seals may be formed in one step utilizing multiple sealing bars at the same time. Alternatively, all of the package seals may be formed simultaneously in a single process step. The food may be placed on a single web, then covered with another, top layer of web and sealed.

The filling and top sealing may be performed with the flexible packages serially connected in a bag chain. Alternatively, the partially formed flexible packages may be separated from one another prior to filling and top sealing and filled individually at a later time. The filling of the package can be carried out using a funnel 62 which is inserted into the opening 64 of the package, such as designated by arrow F. As the funnel 62 is inserted, it spreads open the package and allows for food products 38 to be placed therein. The funnel 62 has an opening sized to permit products to be inserted into the package at relatively high production line speeds. The food 38 is inserted into the top of the funnel 62 in the direction of arrow E and falls through the funnel 62 and into the package. After filling, the funnel 62 is removed and the top seal 16 of the package 10 is made using a pair of horizontal sealing bars 66, which press against the package 10 and then retract in a direction as shown by arrows G and H. The final step is to singulate the packages from the remainder of the web, such as with a knife blade 68. In manufacturing the package 10, shown in FIG. 10, once the food 38 is allowed to drain then another seal 180 is made along the horizontal dividers 18d, 18e, and 18f (i.e., parallel to one of a top or bottom seal) to close off the passages 24a and 24b. The package can be cut along the newly created seal 180 so that the new package 1010 now only consists of a food compartment 20 having a new bottom seal 180.

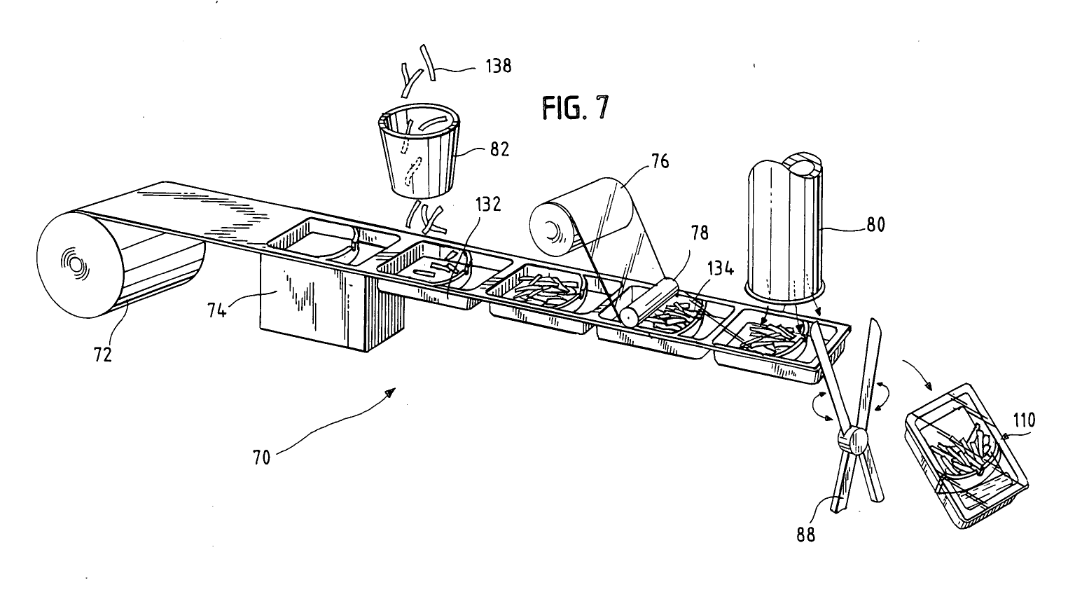

In another example, one method of manufacturing the tray package 110 is depicted using the apparatus 70 as diagrammed in FIG. 7. A web supply roll 72 provides a supply of web material, such as a conventional packaging film for trays. As the web 72 is advanced in a longitudinal process direction, it is disposed over a mold 74 that is shaped to form the cavities of the interior compartments and to form the divider wall 118. As the web 72 is disposed over the mold 74, a vacuum is pulled such that it causes a portion of the plastic web to be pulled inside the mold 74 and to take on the shape of the mold 74. As the tray 132 continues to advance, it moves along in the process direction of the apparatus 70 retaining its newly formed shape. The food compartment 120 of the tray 132 is then filled with the food product 138 using a funnel 82. After filling, film 76 from a roll is laid down on top of the compartments 120 and 122 of the tray 132 to form the top film layer 134. The top film layer 134 is cut with a cutting device 78. A heater 80 may optionally be used to seal the front film 134 to the tray 132. The final step is to singulate the packages 110 from the remainder of the web, such as with a knife blade 88, thus resulting in a filled and sealed tray package 110.

From the foregoing, it will be appreciated a package having at least a food compartment and at least a drainage compartment is provided that allows for storing food in the food compartment while allowing fluid to drain into the drainage compartment in a certain orientation of the package, and for permitting removal of the food without also removing the fluid contained in the drainage compartment. However, the disclosure is not limited to the aspects and embodiments described hereinabove, or to any particular embodiments. Various modifications to the package, dividers, compartments, and methods of manufacturing can result in substantially the same packages.

What is claimed is:

1. A package for storing a food product and fluid, the package comprising:
a pair of opposing panels, the panels being sealed together to define a sealed package interior containing a food product and fluid;
at least one inner divider positioned within the interior to separate a food compartment from a drainage compartment, the at least one inner divider configured to permit fluid to flow from the food compartment toward the drainage compartment when the food compartment is disposed above the drainage compartment; and
a passage between the food compartment and drainage compartment for permitting fluid to drain therebetween.

2. A package for storing a food product and fluid in accordance with claim 1, wherein the at least one inner divider is linear.

3. A package for storing a food product and fluid in accordance with claim 2, wherein the at least one inner divider is generally parallel to one of a top and a bottom seal.

4. A package for storing a food product and fluid in accordance with claim 1, wherein the at least one inner divider is arcuate.

5. A package for storing a food product and fluid in accordance with claim 1, wherein a pair of inner dividers are disposed between the pair of opposing panels and are inclined to facilitate fluid flow in the food compartment towards the passage when the food compartment is elevated above the drainage compartment.

6. A package for storing a food product and fluid in accordance with claim 5, wherein the package is generally rectangular, and has a pair of side seals, a bottom seal and a top seal, and each inner divider intersects one of the side seals.

7. A package for storing a food product and fluid in accordance with claim 6, wherein a volume of the drainage compartment is greater than twice the quantity of fluid in the package interior.

8. A package for storing a food product and fluid in accordance with claim 7, wherein the drainage compartment has at least two reservoir portions, one of the reservoir portions of the drainage compartment being bordered on one side by one of the inner dividers and on another side by the one of the side seals intersected by the one of the inner dividers, and a volume of the one of the reservoir portions being greater than the quantity of fluid in the package interior.

9. A package for storing a food product and fluid in accordance with claim 6, wherein a divider extending parallel to one of the side seals is positioned between the pair of opposing panels and between the pair of inner dividers to divide the interior into two food compartments.

10. A package for storing a food product and fluid in accordance with claim 9, wherein the divider extends from the top seal of the package to the bottom seal to divide the interior into two drainage compartments.

11. A package for storing a food product and fluid in accordance with claim 8, wherein the food product has been prepared using a high pressure process.

12. A package for storing a food product and fluid in accordance with claim 6, wherein at least one of the top, bottom or side seals is a fold.

13. A package for storing a food product and fluid in accordance with claim 1, wherein the package includes means for gaining access to the food compartment.

14. A package for storing a food product and fluid in accordance with claim 1, wherein a back wall of the opposing panels is semi-rigid and a front wall of the opposing panels is flexible.

15. A package for storing a food product and fluid in accordance with claim 1, wherein both a back wall and a front wall of the opposing panels are flexible.

16. A method of forming a package containing a food product and a quantity of fluid, the method comprising:
directing one or more webs of film in a machine direction;
configuring the one or more webs of film to have a pair of opposing package walls;
forming a package interior;
forming at least one inner divider to divide the package interior into a food compartment and a drainage compartment, with a fluid passage therebetween;
inserting a food product into the food compartment of the package interior;
sealing the interior of the package; and
separating the package from the web of film.

17. A method of forming a package in accordance with claim 16, wherein the at least one inner divider is configured to direct at least a portion of the quantity of fluid from the food compartment into the drainage compartment when the food compartment is elevated compared to the drainage compartment.

18. A method of forming a package in accordance with claim 17, wherein the steps of forming a package interior and inner divider include the step of sealing opposing portions of the film together.

19. A method of forming a package in accordance with claim 17, wherein two webs of film are provided, one of the webs being a semi-rigid material and wherein the steps of forming a package interior and inner divider include the step of forming a cavity separated by the inner divider formed from the semi-rigid material.

20. A method of forming a package in accordance with claim 17, wherein the step of forming the inner divider includes the step of forming two inner dividers inclined to direct fluid from the food compartment toward the drainage compartment when the food compartment is elevated compared to the drainage compartment, with a divider extending parallel to a side seal being positioned between the pair of inner dividers to divide the interior into two food compartments

21. A method of forming a package in accordance with claim 17, wherein the inner divider is linear and generally parallel to a top or a bottom seal and the method includes the step of sealing the fluid passage after drainage occurs.

22. A method of forming a package in accordance with claim 21, including the step of separating the drainage compartment from the food compartment.

23. A package for storing a food product and fluid, the package comprising:
a pair of opposing panels, the panels being sealed together to define a package interior; and
at least two inner dividers positioned within the interior between the pair of opposing panels to divide the interior into a food compartment and a drainage compartment, the at least two inner dividers being spaced to define a passage between the food and drainage compartments and inclined to direct fluid to flow from the food compartment toward the drainage compartment when the food compartment is disposed above the drainage compartment.
